(19) United States
(12) Patent Application Publication
(10) Pub. No.: US 2025/0216161 A1
(43) Pub. Date: Jul. 3, 2025

(54) METHOD FOR COATING THE INNER SURFACES OF A HEAT EXCHANGER WITH A POWDERY SOLID CATALYST

(71) Applicants: FIVES CRYO, Golbey (FR); UNIVERSITE DE LORRAINE, Nancy (FR)

(72) Inventors: Gaëtan BERGIN, Golbey (FR); Thierry MAZET, Golbey (FR); Michel VILASI, Bouxières aux Dames (FR); Léo PORTEBOIS, Mirecourt (FR); Nicolas RAMENATTE, crespieres (FR)

(21) Appl. No.: 18/849,519

(22) PCT Filed: Mar. 9, 2023
(86) PCT No.: PCT/EP2023/056059

§ 371 Date: Sep. 22, 2024

(30) Foreign Application Priority Data
Mar. 23, 2022 (FR) FR2202582

(51) Int. Cl. F28F 21/08; B01J 23/745; B01J 37/00; B01J 37/02; F28D 21/00

(52) U.S. Cl. CPC F28F 21/089; B01J 23/745; B01J 37/0018; B01J 37/0225; F28F 21/084; F28D 2021/0022; F28D 2021/0033; F28F 2245/00

(57) ABSTRACT

Disclosed is a method for depositing a coating on inner surfaces forming cavities of a heat exchanger, characterized in that the coating comprises a liquid adhesive and a powder of a pulverulent solid intended to act as a catalyst for a physico-chemical reaction.

### DESIGNATION OF THE RELEVANT TECHNICAL FIELD

The present invention relates to the production of a coating acting as a catalyst for a physico-chemical reaction on metal inner surfaces of a brazed plate heat exchanger, in particular a cryogenic heat exchanger.

### TECHNICAL PROBLEMS ADDRESSED BY THE INVENTION

A brazed plate-and-wave heat exchanger is typically a heat exchanger formed by a metal assembly of brazed plates and corrugations. This type of heat exchanger produces very compact units with large heat exchange surface areas and low pressure drops. This type of heat exchanger is made up of a set of parallel plates between which are inserted intermediate elements, in particular corrugated or wave-like structures. These corrugated structures form cavities with metallic inner surfaces. The stacked plates form between them a stack of flat passages for different fluids to be brought into an exchange relationship.

Such a heat exchanger features metal inner surfaces forming cavities through which at least one fluid flows. The characteristic size of these cavities is of the order of a millimeter, with high aspect ratios (length/width ratio).

The plates and spacers of this type of heat exchanger are typically made of metal.

There are many technologies available for coating a metal substrate, but most of them are inoperative when it comes to coating the inside wall of a metal cavity in such a heat exchanger.

Chemical vapor deposition (CVD) uses a gaseous precursor of the coating to be produced. This precursor can be produced in direct proximity to the surface to be coated (pack cementation) or transported via a gas onto the surface to be coated (out of pack). When transported via a gas, the main limitations of this technology are the rapid depletion of the gas mixture in reactive species, leading to heterogeneities in chemical composition and/or thickness, or even the absence of deposition for surfaces farthest from the carrier gas supply in the case of large structures.

An improvement to this method consists in using a cement consisting of the powder of the metal to be deposited, an inert diluent and an additive, which may be a stripping flux, as described by EP2956566. The viscosity of the cement is adjusted to improve its flowability and enable the filling of the cavities to be coated. In another variant taught by EP3049545, deposition is carried out by liquid means using an aqueous suspension comprising powder of the metal to be deposited and at least one additive which may be selected from a binding agent, a dispersant, etc., the purpose of which is to promote wetting of the surface to be coated.

A thermally-activated consolidation step is then required to extract the organic phase (debinding) and densify the coating. This operation does not always have zero impact on the mechanical properties of the structure to be coated, particularly if the treatment requires a high temperature.

The problem is all the more critical when the material constituting the coating to be deposited is highly reactive towards the substrate, for example when the material of the coating to be deposited is based on iron oxide and the substrate is based on aluminum, this problem stemming from the combination of these two materials which is highly exothermic. In this example, maintaining an iron oxide deposit on the surface of the aluminum-based substrate during a high-temperature assembly operation is not easy, especially if the assembly is carried out by brazing.

This difficulty can be alleviated by installing a diffusion barrier to isolate the coating from the substrate during consolidation. This approach significantly complicates the manufacturing process.

Another difficulty with such coatings is the formation of a deposit whose growth is partly to the detriment of the substrate, particularly if the consolidation heat treatment leads to the formation of intermetallics between the substrate and the coating.

This is one of the major drawbacks with regard to the regulations governing pressure vessels, whose mechanical strength is defined on the basis of a minimum substrate thickness, which can take the form of a wall. All the more so if, by nature, the intermetallics formed between the substrate and the coating are brittle, such as those in the Fe-Al system.

While in the case of conventional equipment this can easily be circumvented by adding a wall thickness, this cannot be envisaged for a brazed plate heat exchanger, whose performance is partly subject to the thickness of the walls making up the plates and corrugated structures. Indeed, for this type of heat exchanger, the wall thinning tolerated is of the same order of magnitude or less than the wall thickness consumed during the coating consolidation stage. As the residual wall thickness cannot be controlled after the fact, this requires perfect control of the precursor deposition conditions.

Another disadvantage of these technologies is the need to produce a totally smooth coating, free from asperities that increase the reactive surface of the deposit.

To the best of our knowledge, conventional coating technologies are unable to achieve an adherent deposit of iron oxide on the surface of an aluminum cavity with a small cross-section and a large length-to-width ratio, greater than 1000.

Whether the deposition is carried out prior to assembly by PVD or CVD, or after assembly using a slip, the subsequent substrate heating required for coating consolidation or assembly leads to the formation of intermetallic compounds that are detrimental to the mechanical integrity of the structure, especially as these intermetallics (Al-Fe) are known to be sensitive to hydrogen embrittlement.

The invention provides a novel solution to these problems.

### SUMMARY OF THE INVENTION

According to a first aspect of the invention, a method is proposed for producing a coating on metal inner surfaces forming cavities of a heat exchanger, the coating being intended to serve as a catalyst for a physico-chemical reaction of ortho-para conversion of hydrogen, said method being characterized in that it comprises the following steps:
a step of depositing a liquid adhesive on the metal inner surfaces, the liquid adhesive being water-based, organic or inorganic, and
a step of depositing a powder of a powdered solid on the deposited liquid adhesive, the powdered solid being a mineral and the powder having a particle size of between 10 μm and 100 μm.

The heat exchanger can be a cryogenic exchanger.

The coating (liner) obtained on the metal inner surfaces of the exchanger according to the method thus serves as a catalyst for a physico-chemical reaction occurring in the exchanger during its operation. The powdered mineral solid is the catalyst. In this way, the heat exchanger combines the function of a conventional heat exchanger, transferring heat between fluids, with that of a physico-chemical reactor.

The liquid adhesive enables the powdered solid to adhere to the exchanger's metal inner surfaces, that is to adhere a mineral phase to a metal surface.

According to one embodiment of the invention, the method comprises, after the powder deposition step, a subsequent step of maintaining the metal inner surfaces at ambient temperature during which the solvents of the liquid adhesive are at least partially removed by evaporation.

Depending on the nature of the adhesive, for example in the case of a thermosetting adhesive, holding it at ambient temperature may be sufficient for it to dry and acquire all its adhesive properties. The holding time is selected to evaporate all the solvents from the adhesive, or the desired proportion of solvents. In particular, it depends on the geometric characteristics of the exchanger and the nature of the adhesive. For example, it takes from a few minutes to two hours at a temperature of between ambient and 100° C.

According to another embodiment of the invention, the method according to the invention comprises, after the powder deposition step, a subsequent step of polymerizing the liquid adhesive by a heat treatment carried out in a temperature range that does not allow the metal inner surfaces to interact with the powdered solid. Depending on the nature of the adhesive, for example in the case of an organic binder, polymerization may be necessary for it to dry and acquire its full adhesive properties. The adhesive is chosen so that polymerization can take place in a sufficiently low temperature range so that the exchanger's metal inner surfaces do not interact with the powdered solid. At higher temperatures, close to the melting point of the brazing alloy used in aluminum brazed plate heat exchangers, the aluminum and brazing alloy become highly reactive with the oxide particles, or mixture of oxides, forming the powdered solid. This would have the effect of forming intermetallic compounds between the substrate and the coating, and reducing the thickness of the aluminum wall.

Thus, the liquid adhesive used to adhere the powdered solid particles to the exchanger's metal inner surfaces is, depending on its nature, removed by evaporation or polymerized during heat treatment.

According to one example, the heat treatment is carried out at a temperature of 200° C. or less. By limiting the temperature at which polymerization is carried out to 200° C., any risk of degrading the mechanical properties of the aluminum is avoided, and the legislation is complied with.

Advantageously, a gas flow is created in the exchanger cavities during the subsequent step of maintaining the metal inner surfaces at ambient temperature, during which solvents in the liquid adhesive are at least partially removed by evaporation, or during the subsequent step of polymerizing the liquid adhesive by heat treatment in a temperature range that does not allow the metal inner surfaces to interact with the powdered solid.

For solvent evaporation at ambient temperature, the flow of gas favors solvent evaporation. The gas can be preheated to enhance evaporation. The gas is, for example, air or nitrogen.

Advantageously, with a powder of the powdery solid whose particle size is between 10 μ and 100 μ, the subsequent step of maintaining the metal inner surfaces at ambient temperature, during which solvents in the liquid adhesive are at least partially removed by evaporation, or polymerization of the liquid adhesive by heat treatment in a temperature range that does not allow the metal inner surfaces to interact with the powdered solid, is carried out after a step of removing the powder of the powdered solid that does not adhere to the liquid adhesive deposited on metal inner surfaces of the exchanger.

After this removal, it is easier to proceed to the subsequent step of maintaining the metal inner surfaces at ambient temperature, during which solvents in the liquid adhesive are at least partially removed by evaporation, or polymerizing the liquid adhesive by heat treatment in a temperature range that does not allow the metal inner surfaces to interact with the powdered solid, which would otherwise be hindered by the presence of excess powder. Indeed, the presence of exceed powder would form a barrier to solvent evaporation, and would add material to be heated unnecessarily in the event of polymerization.

According to one embodiment of the invention, the liquid adhesive may be polyvinyl alcohol and/or a polymer.

Advantageously, the liquid adhesive has a viscosity comparable to that of water, i.e. 1×10⁻³Pa·s at 20° C. The liquid adhesive can thus flow into and fill and/or pass through exchanger cavities, covering all their metal inner surfaces.

In addition, the liquid adhesive has sufficient wettability on the metal inner surfaces to leave a layer of adhesive on them after it has been brought into contact with the metal inner surfaces.

The wettability and viscosity of the liquid adhesive are such that after the liquid adhesive has flowed into the exchanger cavities, adhesive remains on all the exchanger's metal inner surfaces that have been in contact with the liquid adhesive and in the form of a layer of sufficient thickness.

According to the invention, the thickness of the liquid adhesive remaining adhered to the exchanger's metal inner surfaces must be sufficient to properly adhere the powdered solid during the step of depositing the powdered solid on the deposited liquid adhesive. The thickness of the adhesive layer is, for example, between 5 and 50 μm.

According to the invention, the particle size of the powdered solid must not be too large, so that the weight of the particles remains compatible with the adhesion strength of the liquid adhesive. Too large a particle size would result in an excessively heavy powder, which would not stick to the surface of the exchanger cavities properly. As such, the maximum particle size of the powdered solid is chosen according to the density of the powdered solid, the adhesion strength of the adhesive and the thickness of the adhesive on the metal inner surfaces.

Moreover, as the cross-section of the internal cavities is in the order of 1 mm² to 40 mm², the particle size of the powdered solid must remain limited so as not to excessively reduce the cross-section of the process fluid flowing through the exchanger cavities during operation of the exchanger.

In addition, a small particle size of the powdered solid is preferable, as it increases the exchange surface area of the coating resulting from the presence of the particles, and therefore enhances the action of the powdered solid. Given the morphology of the particles, the active surface area of the powdered solid is much greater than that of the metal inner surfaces of the exchanger it covers.

The particle size of the powdered solid is previously adjusted by grinding and filtration to obtain a suitable particle size distribution. A high-energy mill or attritor can be used to obtain a small particle size.

According to one example of the invention, the step of depositing liquid adhesive on the metal inner surfaces is carried out by soaking the exchanger in a bath of liquid adhesive until the cavities are filled, or by circulating liquid adhesive through said cavities.

Dipping is a simple way of coating the exchanger's metal inner surfaces. The exchanger is placed in the bath in an orientation that allows the air in the exchanger cavities to be evacuated and filled by the liquid adhesive. This prevents air from becoming trapped in the heat exchanger, leading to uncoated surfaces. The heat exchanger is kept in the bath for the time required to fill it, e.g. around ten minutes.

Alternatively, the exchanger can be placed with its cavities arranged vertically, or inclined with a major vertical component, and the liquid adhesive poured into the exchanger from its top so that the liquid flows into the exchanger cavities by gravity flow. The lower part of the exchanger can be obstructed so that the liquid adhesive can be fed into the exchanger. The lower part of the exchanger can be left free so that any excess liquid (which does not adhere to the exchanger's inner surfaces) exits the exchanger through its lower end. The amount of adhesive poured must be sufficient to ensure that adhesive is deposited on all the inner surfaces of the exchanger on which a coating is desired.

Once the metal inner surfaces have been coated with adhesive, the powdered solid is deposited.

In one embodiment of the invention, the step of depositing the powdered solid onto the deposited adhesive is carried out by feeding or pouring. For example, a gravity discharge can be used. As with adhesive deposition, the exchanger is then placed with its cavities arranged vertically, or inclined with a major vertical component, and powder of the powdered solid is poured into the exchanger from its top so that the powder flows into the exchanger cavities. Alternatively, the feeding of powder can be carried out with the lower end of the exchanger blocked. The amount of powder poured in such a case must be sufficient to ensure that powder is deposited on all the metal inner surfaces of the exchanger on which a coating is desired.

According to another embodiment of the invention, the step of depositing the powdered solid on the deposited adhesive is carried out by placing the exchanger in a fluidization chamber in which the powdered solid has previously been suspended using a gas.

It would be very difficult, if not impossible, to immerse the exchanger in a tank simply containing the powdered solid, as the mechanical resistance to powder displacement would be too great. By way of analogy, imagine the difficulty of immersing the exchanger in a sandbox.

By fluidizing the powdered solid, it behaves like a liquid. The heat exchanger can then be immersed in the fluidized bed until it is completely covered. Fluidization also facilitates powder flow into the exchanger's internal cavities. The exchanger can be placed in the enclosure with its cavities arranged vertically, or inclined with a major vertical component, to facilitate powder flow through the exchanger.

By adjusting the speed of descent of the exchanger in the fluidization chamber, the cavities are coated with a layer of powdered solid particles with a homogeneous distribution. The rate of coverage of the metal inner surfaces by the powdered solid is therefore very high, exceeding the target minimum of 60%.

As in the previous approach, the chamber in which the exchanger is immersed can be a thermostatically-controlled fluidization chamber for adhesive polymerization.

Advantageously, the gas used to suspend the powdered solid comprises a reagent that interacts with the powdered solid.

Advantageously, the reagent is designed to initiate or accelerate the polymerization of the adhesive. The reagent is, for example, hydrogenated nitrogen to reduce or control the moisture content of the powdered solid.

With the use of a highly fluid liquid adhesive that perfectly covers all the exchanger's metal inner surfaces, and a small-grain powder whose deposition method enables all the previously deposited adhesive to be covered, the invention makes it possible to obtain a consistent coating of a powdery solid on all the exchanger's metal inner surfaces. This provides a large surface area of solid, wherein catalyst, to promote the desired physico-chemical reaction.

According to a second aspect of the invention, a cryogenic heat exchanger is proposed, characterized in that it comprises metal inner surfaces coated with a coating acting as a catalyst for a physico-chemical reaction carried out according to the first aspect of the invention.

Advantageously, the exchanger's metal inner surfaces form cavities with a length-to-width ratio equal to or greater than 1000.

According to an embodiment of the invention, the exchanger is made of aluminum or an aluminum alloy, and the powdered solid is an oxide, a hydroxide, a mixture of oxides or hydroxides, or a mixture of oxides and hydroxides.

Advantageously, the oxide is Fe₂O₃ or the hydroxide is Fe(OH)₃.

The invention is particularly advantageous for cryogenic exchangers of the brazed plate-and-wave type intended for hydrogen production, where the coating of metal inner surfaces obtained according to the invention acts as a catalyst for a physico-chemical reaction of ortho-para hydrogen conversion. This conversion is carried out when the hydrogen is in a liquid state and at a temperature of around −250° C.

### BRIEF DESCRIPTION OF THE FIGURES

Further features and advantages of the invention will become apparent from the following detailed description, which can be understood with reference to the accompanying drawings, wherein:

FIG. 1 is a schematic view of a coating method according to the second embodiment of the invention;

FIG. 2 is a partial schematic view of a cryogenic plate heat exchanger according to one embodiment of the invention, after step C of the coating method shown in FIG. 1;

FIG. 3 is a view similar to FIG. 2, after step D of the coating method shown in FIG. 1;

FIG. 4 is a view similar to FIG. 3, after step F of the coating method shown in FIG. 1; and

FIG. 5 is a partial schematic view of an exchanger according to the invention to illustrate the ratio between the width and length of its internal cavities.

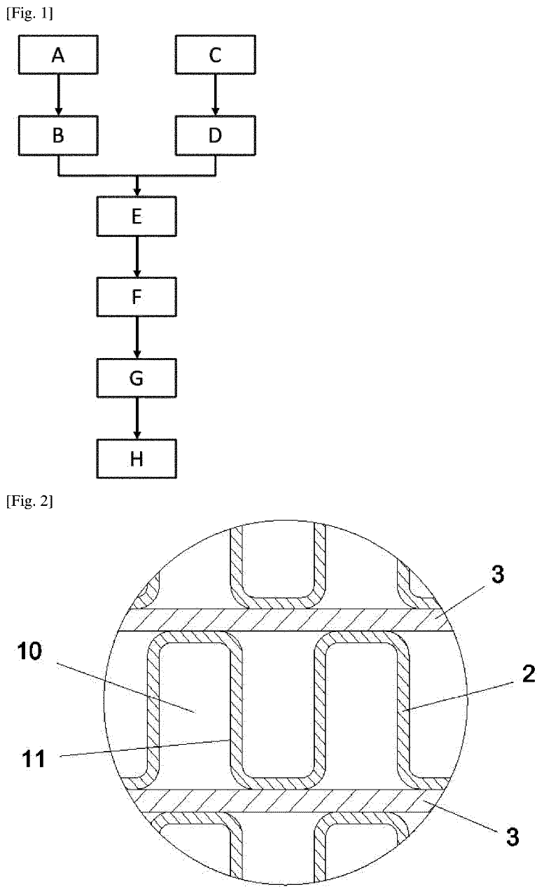

As shown in FIG. 1, in step A, the powder of a powdered solid, that is the catalyst, to be deposited on the metal inner surfaces of heat exchanger 1 is first adjusted in particle size by mechanical grinding followed by dry filtration to obtain and retain only particles of suitable particle size.

In step B, the powder obtained is placed in a fluidization chamber in which it forms a fluidized bed by the circulation of a gas.

In parallel, step C prepares the exchanger 1, whose inner surfaces form the substrate, or wall, to be coated. These surfaces can be etched with a liquid acid solution to ensure perfect adhesion of the adhesive and the powdered solid. FIG. 2 shows a close-up partial cross-section of exchanger 1 after this step C. Corrugations 2 are arranged between two separator plates 3. The corrugations 2 and separator plates 3 form cavities 10 with metal inner surfaces 11.

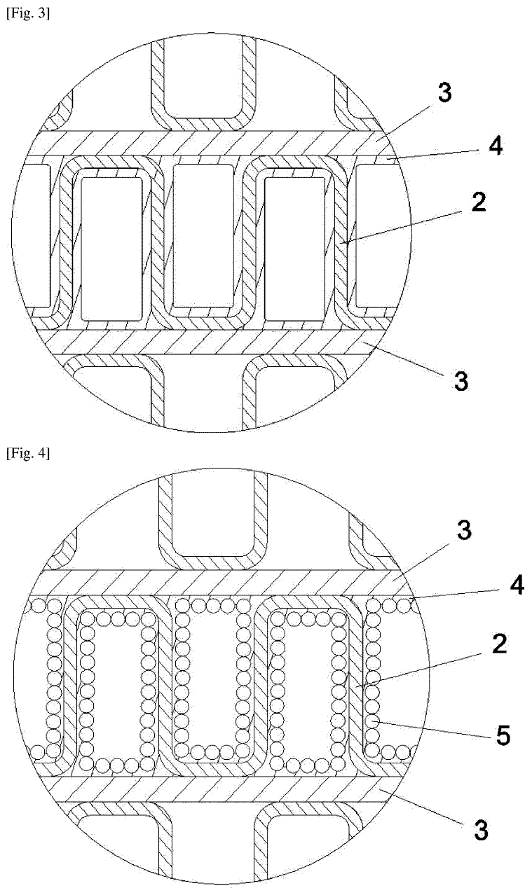

Then, in step D, the adhesive is coated onto the surface of the cavities 10, by dipping in this example. The exchanger 1 is thus immersed in a bath of liquid adhesive at an angle so that the air in the exchanger 1 can escape and be replaced by liquid adhesive. The bath temperature can be controlled to obtain a given adhesive viscosity, e.g. 1×10⁻³Pa·s at 20° C. The exchanger 1 is then removed from the adhesive bath and held above it by arranging the exchanger 1 with its cavities oriented vertically. Excess adhesive therefore gravitates out of the exchanger 1 and falls into the bath. FIG. 3 shows the partial cross-section of FIG. 2 after step D. Inner surfaces of exchanger 1 are covered with adhesive 4.

In stage E, the exchanger 1 is then immersed in the fluidized bed. Advantageously, the descent velocity of the exchanger 1 in the fluidized bed is chosen to be between 0.5 mm/s and 1 m/s, and more preferably between 1 and 10 mm/s.

The exchanger 1 is held in the fluidized bed for a few minutes before being removed.

Advantageously, the extraction velocity of the exchanger 1 from the fluidized bed is chosen to be between 0.5 mm/s and 1 m/s, and more preferably between 1 mm/s and 10 mm/s.

This is followed in step F by removal of the excess powder, which in this example takes place as the exchanger 1 exits the fluidized bed. The exchanger 1 is arranged with its cavities 10 oriented vertically above the powder container. Particles that are not held by the adhesive thus flow by gravity out of the exchanger 1. To facilitate this flow, the exchanger 1 can be gently shaken and/or a gas can be injected into the exchanger 1 to mechanically entrain the loose particles. FIG. 4 shows the partial cross-section of FIG. 3 after step F. Particles 5 of the powdered solid are held on the inner surfaces of the exchanger 1 by the adhesive.

Please note that the figures schematically illustrate one exemplary embodiment of the invention. The ratios between the dimensions of the elements shown are not necessarily representative of the actual ratios. Thus, the size of the particles 5 and the thickness of the adhesive 4 in FIG. 4 are not necessarily representative of their actual dimensions compared with those of the waves and separator plates shown and the cavities they form.

In step G, the exchanger 1 is then placed in a thermostatic chamber where it can be heated to 150° C. for several tens of minutes to polymerize the adhesive.

In step H, the exchanger 1 is removed from the thermostatic chamber and returned to ambient temperature.

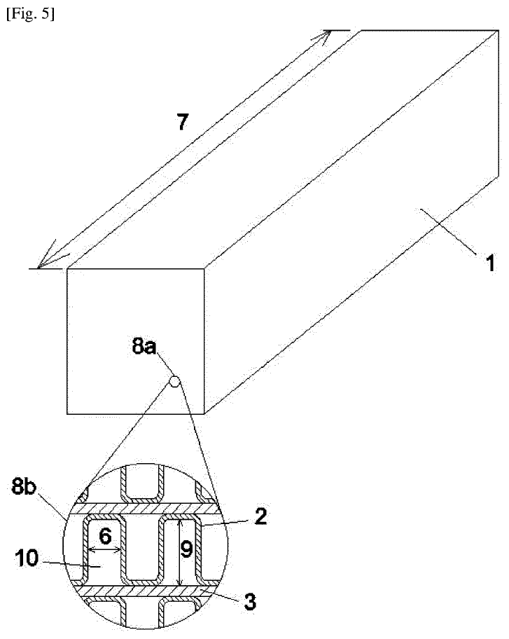

FIG. 5 shows a schematic diagram of an exchanger 1 according to the invention. The distance 6 illustrates the width of a cavity and distance 7 its length. According to the invention, the catalyst-coated cavities of the exchanger 1 have a length/width ratio equal to or greater than 1000. As shown in the enlargement 8b of the circular portion 8a of the exchanger 1, the corrugation 2 forms a cavity 10 with a separator plate 3, of width 6 and height 9. For the purposes of calculating the ratio between cavity width and length, the width of the cavity is taken to be the smaller of its width or height. In this example, the length/width ratio is 7/6.

1. A method for producing a coating on metal inner surfaces forming cavities of a heat exchanger, the coating being intended to serve as a catalyst for a physico-chemical reaction of ortho-para conversion of hydrogen, said method being characterized in that it comprises the following successive steps:
a step of depositing a liquid adhesive on the metal inner surfaces, the liquid adhesive being water-based, organic or inorganic, and
a step of depositing a powder of a powdered solid on the deposited liquid adhesive, the powdered solid being a mineral and the powder having a particle size of between 10 μm and 100 μm.

2. The method according to claim 1, further comprising, after the powder deposition step, a subsequent step of maintaining the inner surfaces at ambient temperature during which the solvents of the liquid adhesive are at least partially removed by evaporation.

3. The method according to claim 1, further comprising, after the powder deposition step, a subsequent step of polymerizing the liquid adhesive by a heat treatment carried out in a temperature range which does not allow the inner surfaces to interact with the powdered solid.

4. The method according to claim 3, wherein the heat treatment is carried out at a temperature less than or equal to 200° C.

5. The method according to claim 2, wherein a gas flow is created in the exchanger cavities during the subsequent step of maintaining the inner surfaces at ambient temperature, during which solvents in the liquid adhesive are at least partially removed by evaporation, or during the subsequent step of polymerizing the liquid adhesive by heat treatment in a temperature range that does not allow the inner surfaces to interact with the powdered solid.

6. The method according to claim 2, wherein the subsequent step of maintaining the inner surfaces at ambient temperature, during which solvents in the liquid adhesive are at least partially removed by evaporation, or polymerization of the liquid adhesive by heat treatment in a temperature range that does not allow the metal inner surfaces to interact with the powdered solid, is carried out after a step of removing the powder of the powdered solid that does not adhere to the liquid adhesive deposited on inner surfaces of the exchanger.

7. The method according to claim 1, wherein the liquid adhesive is polyvinyl alcohol and/or a polymer.

8. The method according to claim 1, wherein the liquid adhesive has a viscosity comparable to that of water.

9. The method according to claim 1, wherein the liquid adhesive has sufficient wettability on the inner surfaces to leave a layer of adhesive thereon after it has been brought into contact with the inner surfaces.

10. The method according to claim 1, wherein the exchanger is made of aluminum, or of an aluminum alloy, and in that the powdered solid is an oxide or hydroxide or a mixture of oxides or hydroxides, or a mixture of oxides and hydroxides.

11. The method according to claim 10, wherein the oxide is Fe2O3 or the hydroxide is Fe(OH)3.

12. The method according to claim 10, wherein the powder of the powdery solid has a particle size of between 50 nm and 1 μm.

13. The method according to claim 1, wherein the step of depositing liquid adhesive on the metal inner surfaces is carried out by dipping the exchanger in a bath of liquid adhesive until the cavities are filled, or by circulating liquid adhesive through said cavities.

14. The method according to claim 1, wherein the step of depositing the powder of the powdered solid onto the deposited adhesive is carried out by feeding or pouring.

15. The method according to claim 1, wherein the step of depositing the powdered solid on the deposited adhesive is carried out by placing the exchanger in a fluidization chamber in which the powdered solid has previously been suspended using a gas.

16. The method according to claim 15, wherein the gas for suspending the powdered solid comprises a reagent interacting with the powdered solid.

17. The method according to claim 16, wherein the reagent initiates or accelerates the polymerization of the adhesive.

18. A cryogenic heat exchanger comprising metal inner surfaces coated with a coating acting as a catalyst for a physico-chemical reaction carried out according to claim 1.

19. The heat exchanger according to claim 18, wherein the metal inner surfaces form cavities whose length-to-width ratio is greater than or equal to 1000.
